(19) United States
(12) Patent Application Publication
(10) Pub. No.: US 2006/0133842 A1
(43) Pub. Date: Jun. 22, 2006

(54) Printing apparatus

(75) Inventors: Satoshi Obata, Mishima-shi (JP); Masaaki Sei, Shizuoka-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Chiyoda-ku (JP)

(21) Appl. No.: 11/015,455

(22) Filed: Dec. 16, 2004

(51) Int. Cl. G03G 15/00

(52) U.S. Cl. 399/82

(57) ABSTRACT

An image forming apparatus includes a determination unit configured to determine whether image data associated with printing setting data indicative of a printing setting can be printed at the printing setting, a first printing processing unit configured to print the image data at the printing setting when the determination unit determines that the image data can be printed, a printing setting changing unit configured to change the printing setting data to printable setting data when the determination unit determines that the image data cannot be printed, and a second printing processing unit configured to print the image data at a printing setting changed by the printing setting changing unit.

### BACKGROUND OF THE INVENTION

1. Field of the Invention

The present invention relates to a printing apparatus capable of printing by varying a printing setting.

2. Description of the Related Art

A printing apparatus to perform printing based on a print job sent from a personal computer (PC) on which a printer driver is installed is generally known. This printing apparatus is, for example, a printer and a multifunction peripheral (MFP) having a printer function. To do printing, a user operates the PC to make a printing setting on a printer driver. The PC supplies the printing apparatus with a print job that is based on the printer setting. The print job includes printing setting data indicative of the printing setting made by the printer driver and image data to be printed. The printing apparatus prints the image data included in the print job based on the printing setting.

There is a printing apparatus that discharges paper sheets into different destinations. In this printing apparatus, however, some paper sheets may not be discharged depending on their types. This is for mechanical reasons, such as the reason that a printing paper sheet cannot be discharged by a discharging roller when it is an envelope or the like. If a print job including such a setting is executed, printing is interrupted or a jam occurs.

The printing setting can be made by the printer driver irrespective of whether the printing apparatus can perform printing. For example, a staple-sort can be set to a printing apparatus having not a staple unit but a sorter. Even though the printing apparatus receives a print job of the printing setting, it cannot perform any staple operation.

Some printing apparatuses have a function of storing image data used for copying. The image data so stored is printed at the same setting as when the image data is stored. When the image data stored when a printing apparatus performs double-sided printing is moved to and printed by another printing apparatus, its printing will be stopped if the latter printing apparatus has no automatic duplexing unit (ADU).

Accordingly, there is a need for a printing apparatus capable of printing by changing a printing setting to a printable one.

### BRIEF SUMMARY OF THE INVENTION

According to an aspect of the present invention, an image forming apparatus comprises a determination unit configured to determine whether image data associated with printing setting data indicative of a printing setting can be printed at the printing setting, a first printing processing unit configured to print the image data at the printing setting when the determination unit determines that the image data can be printed, a printing setting changing unit configured to change the printing setting data to printable setting data when the determination unit determines that the image data cannot be printed, and a second printing processing unit configured to print the image data at a printing setting changed by the printing setting changing unit.

Objects and advantages of the invention will become apparent from the description which follows, or may be learned by practice of the invention.

### BRIEF DESCRIPTION OF THE SEVERAL VIEWS OF THE DRAWING

The accompanying drawings illustrate embodiments of the invention, and together with the general description given above and the detailed description given below, serve to explain the principles of the invention.

FIG. 1 is a schematic diagram of a network structure common to the respective embodiments of the present invention;

FIG. 2 is a perspective view of the outward appearance of an MFP common to the respective embodiments of the present invention;

FIG. 3 is a schematic diagram of a part of an image forming apparatus common to the respective embodiments of the present invention;

FIG. 4 is a schematic diagram of another part of the image forming apparatus common to the respective embodiments of the present invention;

FIG. 5 is a schematic diagram of a computer apparatus common to the respective embodiments of the present invention;

FIG. 6 is a flowchart showing a process according to a first embodiment of the present invention; and

FIG. 7 is a flowchart showing a process according to a second embodiment of the present invention.

### DETAILED DESCRIPTION OF THE INVENTION

The structure common to the respective embodiments will be first described with reference to the drawings. The respective embodiments will be described later.

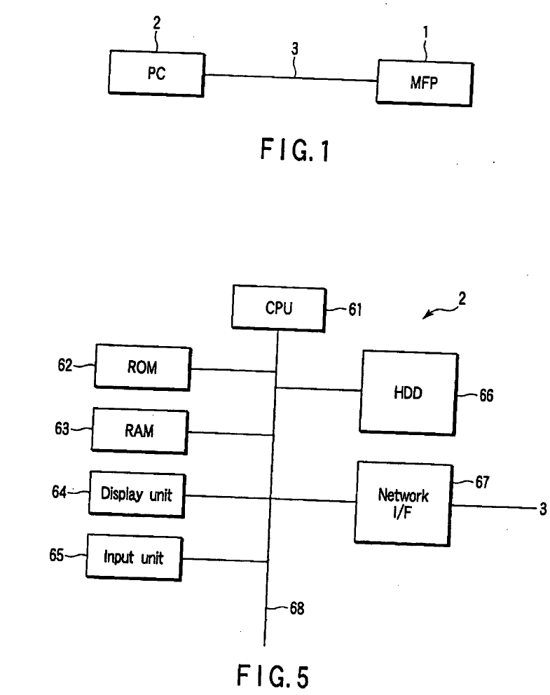

FIG. 1 is a diagram of a network structure common to the respective embodiments. An MFP 1 and a PC 2 are connected to each other by a local area network (LAN) 3.

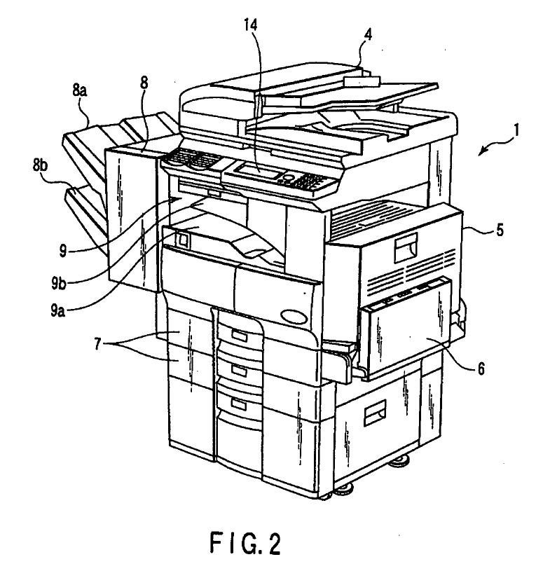

FIG. 2 is a perspective view of the outward appearance of the MFP 1. The MFP 1 includes a control panel 14, an automatic document feeder (ADF) 4, an automatic duplexing unit (ADU) 5, a manual paper feeding tray 6, a paper feeding cassette 7 and a finisher 8.

The finisher 8 includes a first tray 8a and a second tray 8b arranged under the first tray 8a. The first and second trays 8a and 8b each serve as a discharge destination of printed paper sheets. The printed paper sheets can be discharged to a discharge unit 9a that is provided in a body 9 of the MFP 1. A third tray 9b can be inserted into the body 9 and above the discharge unit 9a such that the paper sheets can distinguishably be discharged to the discharge unit 9a. The third tray 9b allows paper sheets to be discharged onto the discharge unit 9a and the third tray 9b.

The paper sheets printed by the MFP 1 are therefore discharged to any one of the first tray Ba, second tray 8b, discharge unit 9a and third tray 9b. A combination of a media type and a paper size can be considered as the type of paper sheets printable by the MFP 1. The media type is plain paper, cardboard, OFP paper, tabloid paper, an envelope, a postcard, waterproof paper and the like. The paper size is AB, LT, postcard size, wide-paper size, long-paper size and the like. There is a case where the discharge destination is restricted according to the above types of paper sheets. If the thickness of a paper sheet exceeds the thickness limitation of paper sheets that can be sent out by a carrying roller in the finisher 8, the paper sheet needs to be discharged to the discharge unit 9a. If a paper sheet is longer than the body 9, it needs to be discharged to one of the first and second trays 8a and 8b neither of which restricts the paper size. Of the first tray 8a, second tray 8b, discharge unit 9a and third tray 9b, the discharge unit 9a in the body 9, which restricts the paper size, is a discharge destination that is adaptable to the largest number of paper types.

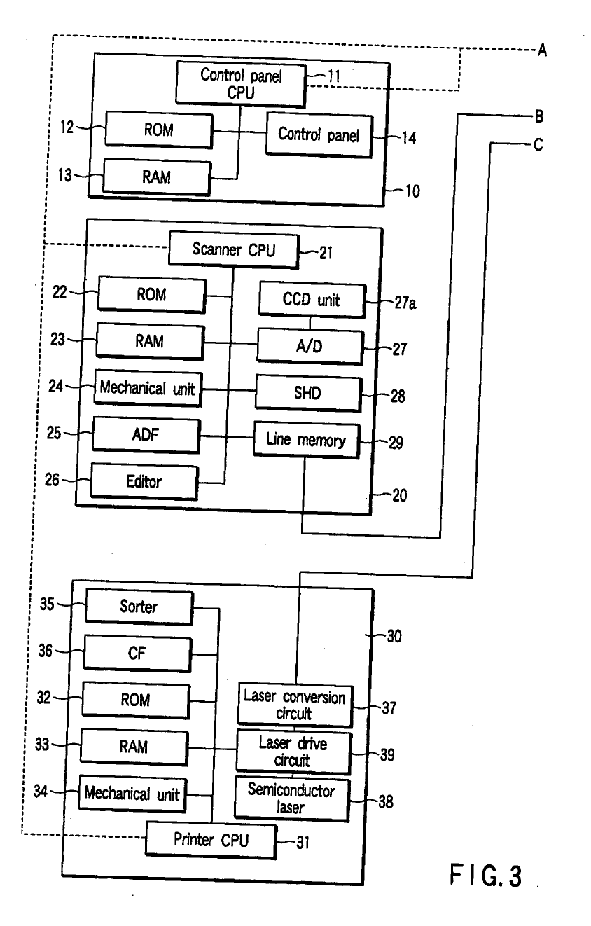

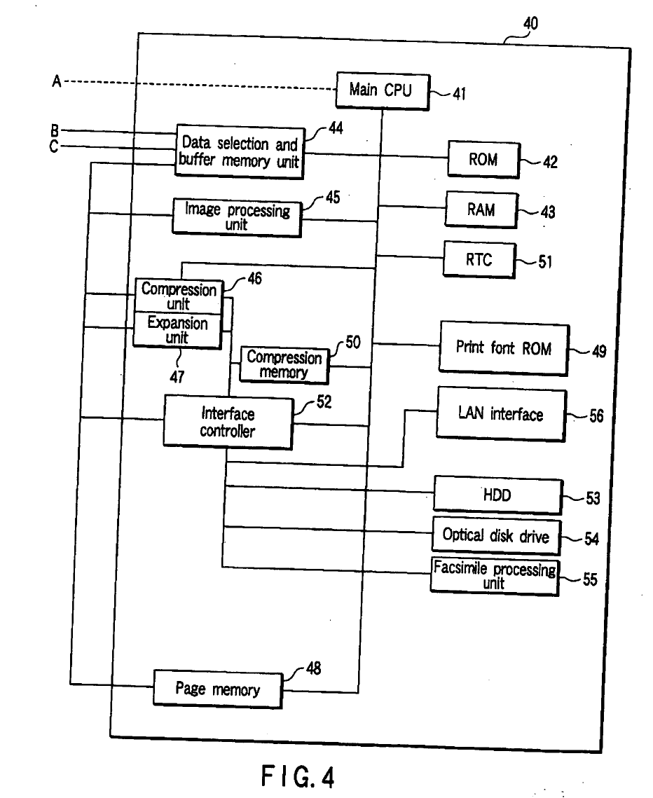

FIGS. 3 and 4 are diagrams of the internal structure of the MFP 1. FIG. 2 shows the internal structure of a control panel unit 10, a scan unit 20 and a printer unit 30 of the MFP 1, and FIG. 3 shows the internal structure of a basic processing unit 40 of the MFP 1.

Referring to FIGS. 2 and 3, the basic processing unit 40, control panel unit 10, scan unit 20 and printer unit 30 are controlled by a main CPU 41, a control panel CPU 11, a scan CPU 21 and a printer CPU 31, respectively. The main CPU 41 communicates with the control panel CPU 11, scan CPU 21 and printer CPU 31 and controls these CPUs.

The control panel CPU 11 is connected to a ROM 12 and a RAM 13. The control panel CPU 11 controls the control panel 14 based on the data stored in the ROM 12 and the RAM 13. The control panel 14 includes a touch panel, function keys such as a start key, and numeric keys.

The scan CPU 21 controls a mechanical unit 24 of, e.g., a motor and a solenoid (neither of which is shown) based on the data stored in a ROM 22 and a RAM 23 and also controls an automatic document feeder (ADF) 25, a coordinate input unit (editor) 26, an analog-to-digital conversion circuit (A/D) 27, a shading correction circuit (SHD) 28, a line memory 29 and the like. A charge-coupled device (CCD) unit 27a is connected to the A/D 27.

The printer CPU 31 controls a mechanical unit 34 of, e.g., a motor and a solenoid (neither of which is shown) based on the data stored in a ROM 32 and a RAM 33 and also controls a controlling a sorter 35, a cassette feeder (CF) 36, a laser conversion circuit 37 and a laser drive circuit 39 for a semiconductor laser 38. The printer unit 30 can form a color image by superimposing toner images of four colors of yellow, cyan, magenta and black based on given image data. The paper sheets printed by the printer unit 30 are discharged to any one of the above first tray Ba, second tray 8b, discharge unit 9a and third tray 9b.

The main CPU 41 controls the whole MFP 1 in accordance with the control programs and fixed data stored in a ROM 42 and a RAM 43.

A data selection and buffer memory unit 44 determines where image data read by the scan unit 20 is sent or selects and buffers data that is sent to the printer unit 30. An image processing unit 45 processes the image data that is sent from the data selection and buffer memory unit 44 and read by the scan unit 20. A compression unit 46 compresses the image data and an expansion unit 47 expanses the compressed image data. A page memory 48 stores image data for each page. A print font ROM 49 expands code data on the page memory 48, and compression memory 50 stores the data compressed by the compression unit 46. A real time clock (RTC) 51 generates present time information.

The main CPU 41 is connected to a hard disk drive (HDD) 53, an optical disk drive 54, a facsimile processing unit 55 and a local area network (LAN) interface 56 through an interface controller 52. The optical disk drive 54 reads information out of a set disk. The facsimile processing unit 55 transfers the processed image data to the outside through a communication line (not shown) connected to the MFP 1 or receives image data from the outside through the communication line. The LAN interface 56 is used for a connection with the LAN 3.

The HDD 53 stores various data items and control programs such as electronic document files. The electronic document files are, for example, image data associated with printing setting data.

FIG. 5 is a schematic diagram of the internal structure of the PC 2. The PC 2 has a CPU 61, a ROM 62, a RAM 63, a display unit 64, an input unit 65, an HDD 66 and a local area network (LAN) interface 67. The CPU 61 is connected to the ROM 62, RAM 63, display unit 64, input unit 65, HDD 66 and LAN interface 67 through a bus line 68.

The CPU 61 executes control programs stored in the ROM 62 to control the respective units in their entirety. The ROM 62 stores control programs to be executed by the CPU 61. The RAM 63 has a work area necessary for performing various processes by the CPU 61. The display unit 64 is, for example, a display to display information for a user. The input unit 65 is, for example, a keyboard and a mouse used for inputting user's instructions. The HDD 66 stores various data items such as image data and control programs. The HDD 66 includes a printer driver storage unit 66a that stores a printer driver for sending a print job to the MFP 1. The LAN interface 67 is used for a connection with the LAN 3.

Embodiments of the present invention will be described with reference to the accompanying drawings.

### First Embodiment

A first embodiment will be described first. Upon receiving a print job created by the PC 2, the MFP 1 can print based on printing setting data and image data included in the print job. The printing setting data includes at least data indicative of the type of paper sheets and the discharge destination. The printing setting of the print job is made by a user using the printer driver of the PC 2.

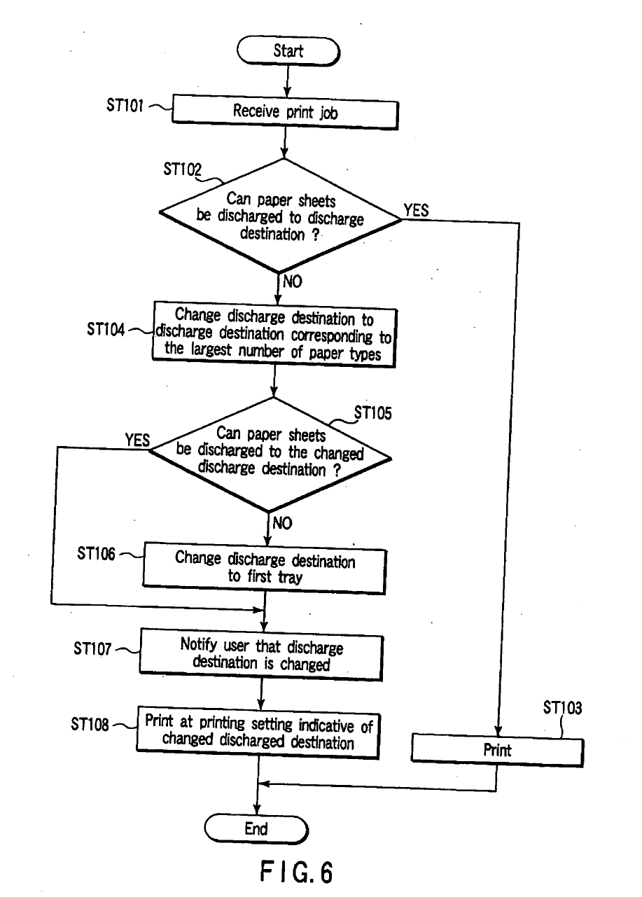

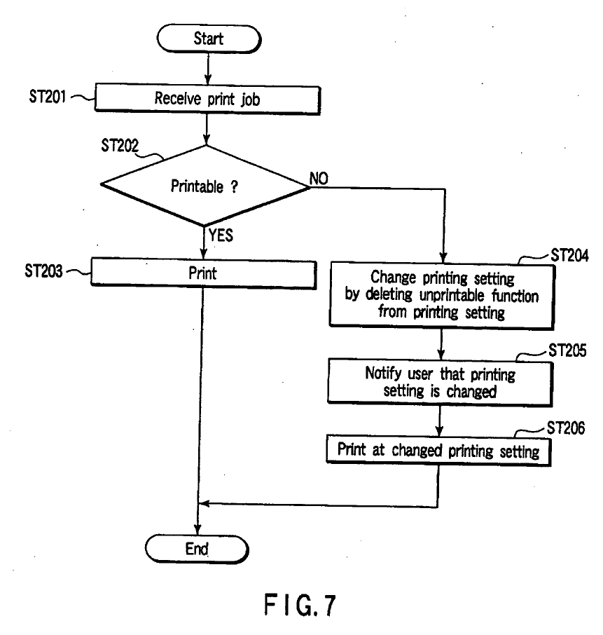

FIG. 6 is a flowchart showing a process to be executed by the main CPU 41 of the MFP 1 upon receipt of a print job from the PC 2.

When the main CPU 41 receives a print job (ST101), it determines whether paper sheets can be discharged to a discharge destination set by the printing setting included in the print job (ST102). If the main CPU 41 determines that the paper sheets can be discharged, it performs printing based on the printing setting included in the print job (ST103). On the other hand, if the main CPU 41 determines that the paper sheets cannot be discharged, it changes the discharge destination to one that is adaptable to the largest number of paper types (ST104). In the first embodiment, the discharge destination is changed to the discharge unit 9a. After that, the main CPU 41 determines whether the paper sheets can be discharged to the changed discharge destination (ST105). If the main CPU 41 determines that the paper sheets cannot be discharged, it changes the discharge destination to the first tray Ba (ST106). When the main CPU 41 determines that the paper sheets can be discharged (YES in ST105) and changes the discharge destination to the first tray Ba in step ST106, it notifies the user of the change of the discharge destination (ST107). This notification is made by sending information for pop-up-displaying the discharge destination on the display unit 64 of the PC 2 as the contents of the changed printing setting from the main CPU 41 to the PC 2. The main CPU 41 performs printing based on the changed printing setting (ST108).

An example of an operation performed when a user operates the PC 2 to cause the MFP 1 to do printing will be described. The user operates the PC 2 to start up given application software and open a file to be printed. Then, the user uses the printer driver to set a discharge destination as the third tray 9b and the paper type as A3 size and plain paper, and gives an instruction to do printing. As the instruction is so given, the CPU 61 of the PC 2 sends the print job to the MFP 1. A3-size paper sheets do not remain in either the discharge unit 9a or the third tray 9b.

When MFP 1 receives the print job, it determines whether paper sheets can be discharged to the discharge destination. The MFP 1 determines that A3-size paper sheets do not remain in the third tray 9b and changes the discharge destination to the discharge unit 9a. Since, however, the A3-size paper sheets cannot be discharged even to the discharge unit 9a, the discharge destination is changed to the first tray 8a of the finisher 8. At this time, the display unit 64 of the PC 2 pop-up-displays the discharge destination changed to the first tray 8a The image data included in the print job is printed and then the paper sheets are discharged to the first tray 8a.

Even though a user receives a print job to which an unavailable discharge destination is set, the MFP 1 can change the setting of the discharge destination and perform printing. The MFP 1 can thus prevent printing from intermitting or stopping and also prevent a jam from occurring. Consequently, the MFP 1 can improve in printing efficiency more than the prior art MFP.

When the discharge destination is changed, first, the MFP 1 changes the setting such that paper sheets can be discharged to the discharge unit 9a that is adaptable to the largest number of paper types among the discharge destinations of the first tray 8a, second tray 8b, discharge unit 9a and third tray 9b. When the paper sheets cannot be discharged to a discharge destination, the discharge destination can be changed on a priority basis to one to which they can be discharged with efficiency.

If paper sheets cannot be discharged to the discharge unit 9a, or if the paper size that is larger than the size of the discharge unit 9a is set as a paper type, they are discharged to the first tray Ba that does not restrict the size of paper sheets to be discharged. Even though paper sheets that cannot be discharged to the discharge unit 9a are set, printing can be prevented from intermitting. In this case, the paper sheets are discharged to the first tray 8a arranged in the uppermost area in the finisher 8. A user can thus pick up the discharged paper sheets more easily than the case where they are discharged to the second tray 8b.

The information indicative of the changed discharge destination is displayed on the display unit 64 of the PC 2. A user can thus visually confirm the changed discharge destination.

### Second Embodiment

Next, a second embodiment will be described. When the MFP 1 receives a print job created by the PC 2, it can perform printing based on printing setting data and image data included in the print job. The printing setting data includes at least data indicating a printing method such as a staple, a sort and a double-sided printing. The printing setting of the print job is made by a user using the printer driver of the PC 2.

FIG. 7 is a flowchart showing a process to be executed by the main CPU 41 of the MFP 1 upon receipt of a print job from the PC 2.

When the main CPU 41 receives a print job (ST201), it determines whether printing can be performed at the printing setting included in the print job (ST202). If the main CPU 41 determines that the printing can be done, it performs the printing based on the printing setting included in the print job (ST203). On the other hand, if the main CPU 41 determines that the printing cannot be done in step ST202, it deletes the unprintable setting and changes the printing setting (ST204). When both a staple and a sort are set, if a staple operation cannot be performed because a staple device is not added to the MFP 1, the setting of the staple is deleted and the printing setting is changed to perform only the sort. Even though a staple device is added to the MFP 1, the main CPU 41 determines that a staple operation cannot be performed if no staples are prepared or the finisher 8 is not attached to the MFP 1. When the main CPU 41 changes the printing setting as described above, it notifies a user of the change of the printing setting (ST205). This notification is made by sending information for pop-up-displaying the changed printing setting on the display unit 64 of the PC 2 from the main CPU 41 to the PC 2. The main CPU 41 performs printing based on the changed printing setting (ST206).

An example of an operation performed when a user operates the PC 2 to cause the MFP 1 to do printing will be described. The user operates the PC 2 to start up given application software and open a file to be printed. Then, the user uses the printer driver to set a staple and a sort and gives an instruction to do printing. As the instruction is so given, the CPU 61 of the PC 2 sends the print job to the MFP 1.

When the MFP 1 receives the print job, it determines whether printing can be performed at the printing setting. Since no staple device is attached, the MFP 1 determines that it cannot perform a staple operation and changes the printing setting to only the sort. At this time, the display unit 64 of the PC 2 pop-up-displays the printing setting changed to only the sort. The image data included in the print job is printed by sorting.

Even though the MFP 1 receives a print job with a user's unavailable printing setting, it can delete the unavailable printing setting and change it to an available printing setting to do printing. The MFP 1 can thus prevent printing from intermitting or stopping. Consequently, the MFP 1 can improve in printing efficiency more than the prior art MFP.

The information indicative of the changed printing setting is displayed on the display unit 64 of the PC 2. A user can thus visually confirm the changed printing setting.

The change in printing setting is not limited to the deletion of a staple. When a print job including a printing setting of double-sided printing is sent to an MFP having no ADU, the setting of the double-sided printing is deleted and single-sided printing is done.

In the foregoing embodiments, the MFP 1 receives a print job created by the PC 2 and performs printing based on printing setting data and image data included in the print job. However, the embodiments are not limited to this. For example, the MFP 1 can store the received print job in the HDD 53 in association with the printing setting data and image data. A user operates the control panel 14 of the MFP 1 to print the image data stored in the HDD 53. In place of the reception of the print job in each of the above steps ST101 and ST201, a process for receiving an instruction to perform such an operation is executed. In this configuration, too, the MFP 1 can change the printing setting and perform printing. Even when image data is stored in the HDD 53 in association with the printing setting data transferred through the LAN 3 or the like, the MFP 1 can also change the printing setting and perform printing.

When printing is performed by operating the control panel 14 as described above, the touch panel of the control panel 14 displays the changed printing setting. The user can thus be notified of the changed printing setting.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the inventive as defined by the appended claims and equivalents thereof.

What is claimed is:

1. A printing apparatus comprising:
a determination unit configured to determine whether image data associated with printing setting data indicative of a printing setting can be printed at the printing setting;
a first printing processing unit configured to print the image data at the printing setting when the determination unit determines that the image data can be printed;
a printing setting change unit configured to change the printing setting data to printable setting data when the determination unit determines that the image data cannot be printed; and
a second printing processing unit configured to print the image data at a printing setting changed by the printing setting change unit.

2. The printing apparatus according to claim 1, further comprising a notification unit configured to make a notification about contents of the printing setting changed by the printing setting change unit.

3. A printing apparatus having a plurality of discharge destinations, comprising:
a determination unit configured to determine whether paper sheets can be discharged to at least one of the discharge destinations when image data associated with printing setting data indicative of the one of the discharge destination is printed;
a first printing processing unit configured to print the image at the printing setting when the determination unit determines that the paper sheets can be discharged;
a discharge destination change unit configured to change the printing setting data such that the one of the discharge destinations is changed to an available discharge destination when the determination unit determines that the paper sheets cannot be discharged; and
a second printing processing unit configured to print the image data at a printing setting changed by the discharge destination change unit.

4. The printing apparatus according to claim 3, further comprising a notification unit configured to make a notification about contents of the printing setting changed by the discharge destination setting change unit.

5. The printing apparatus according to claim 3, further comprising a reception unit configured to receive a print job through a network, the print job including the printing setting data and the image data.

6. The printing apparatus according to claim 3, further comprising a storage unit which stores the image data associated with the printing setting data.

7. The printing apparatus according to claim 3, wherein the discharge destination changed by the discharge destination change unit is one of the discharge destinations which is adaptable to the largest number of paper types.

8. The printing apparatus according to claim 7, wherein the one of the discharge destinations which is adaptable to the largest number of paper types is a discharge unit provided in a body of the printing apparatus.

9. A printing apparatus comprising:
a determination unit configured to determine whether image data associated with printing setting data can be printed at the printing setting;
a first printing processing unit configured to print the image data at the printing setting when the determination unit determines that the image data can be printed;
a printing setting deletion unit configured to delete an unprintable setting from the printing setting data when the determination unit determines that the image data cannot be printed; and
a second printing processing unit configured to print the image data at a printing setting deleted by the printing setting deletion unit.

10. The printing apparatus according to claim 9, further comprising a notification unit configured to make a notification about contents of the printing setting changed by the printing setting deletion unit.

11. The printing apparatus according to claim 9, further comprising a reception unit configured to receive a print job through a network, the print job including the printing setting data and the image data.

12. The printing apparatus according to claim 9, further comprising a storage unit which stores the image data associated with the printing setting data.

13. The printing apparatus according to claim 9, wherein the deleted printing setting is a setting of double-sided printing.

14. The printing apparatus according to claim 9, wherein the deleted printing setting is a setting of a staple.

15. A method of printing by changing a printing setting of a printing apparatus, comprising:
determining whether image data associated with printing setting data indicative of a printing setting can be printed at the printing setting;
printing the image data at the printing setting when it is determined that the image data can be printed;
changing the printing setting data to printable setting data when it is determined that the image data cannot be printed; and
printing the image data at the changed printing setting.

16. The method according to claim 15, further comprising making a notification about contents of the changed printing setting.
